(19) United States
(12) Patent Application Publication
(10) Pub. No.: US 2002/0112244 A1
(43) Pub. Date: Aug. 15, 2002

(54) Collaborative video delivery over heterogeneous networks

(76) Inventors: Shih-Ping Liou, West Windsor, NJ (US); Ruediger Schollmeier, Gauting (DE); Kilian Heckrodt, Princeton, NJ (US)

Correspondence Address: Siemens Corporation, Intellectual Property Department, 186 Wood Avenue South, Iselin, NJ, 08830, US

(21) Appl. No.: 10/022,081

(22) Filed: Dec. 13, 2001

Related U.S. Application Data
(60) Provisional application No. 60/256,650, filed on Dec. 19, 2000.

(51) Int. Cl. H04N 7/173; H04L 12/28; H04L 12/56

(52) U.S. Cl. 725/93; 725/117; 725/97; 370/395.21; 725/88; 725/95

(57) ABSTRACT

There is provided a system for collaboratively delivering a video stream over a heterogeneous network. The video stream includes a plurality of frames. The system includes a session controller for synchronizing with client devices, receiving messages, and outputting encoder control commands based on the messages. The system further includes a plurality of encoders. Each encoder is dedicated to a corresponding one of the client devices for receiving user control commands from the corresponding one of the client devices that correspond to a playback of the video stream, outputting the messages based on the user control commands, and respectively controlling a transmission of the video stream to the corresponding one of the client devices using a shared timeline, including respectively and dynamically transmitting or discarding each of the plurality of frames so as to cooperatively maintain a minimum quality of service for all of the client devices.

### RELATED APPLICATION DATA

This is a non-provisional application claiming the benefit of provisional application Ser. No. 60/256,650, entitled “Collaborative Video Delivery Over Mobile Networks”, filed on Dec. 19, 2000, which is incorporated by reference herein.

### BACKGROUND

1. Technical Field

The present invention generally relates to networks and, in particular, to collaborative video delivery over heterogeneous networks involving wired and wireless connections, where the quality of presentation is maintained.

2. Background Description

Imagine that you are a field engineer working on a routine maintenance on a client site. During your visual inspection, you suspect a crack on a turbine blade and would like to discuss this finding with colleagues in the remote service center. You connect a camera to your laptop and, through a wireless ISP, connect the laptop to the remote service center. You would focus your camera on the surface of a turbine blade, and sometimes move around upon the request of your colleagues. The system is able to decide what frames to send to the remote service center for making the best use of the wireless connection. Your colleagues see “slide shows” with excellent quality and are able to conduct a very productive discussion with you.

One such product is SPRINT'S DRUMS system which allows two users to view video simultaneously by using the SHARED MOVIE PLAYER that runs on SILICON GRAPHICS, INC. computers. The shared video playback starts with one of the users sending the video file (in SGI Movie Player format) to be shared to the other user. Once the complete video has been transferred, any of the two users can initiate video playback. The playback control is also shared. Any of the two users can pause the video, jump to a random position in the video by use of a scrollbar, or playback video in reverse direction. However, disadvantageously, the SHARED MOVIE PLAYER does not provide features such as quality of service (QOS) over collaborative video delivery or multi-user conferencing. With respect to the former (QOS), the SHARED MOVIE PLAYER assumes a good connection speed and does not take into account the maintaining of the quality of presentation so that users will not loose the context when network connection degrades from time to time. With respect to the latter (multi-user conferencing), the SHARED MOVIE PLAYER only works for point-to-point conferencing. The SHARED MOVIE PLAYER is further described at http://www.sprint.com/drums/index.html.

A collaborative dynamic video annotation apparatus to facilitate online multi-point discussions on video content over heterogeneous networks is described by in U.S. Ser. No. 09/039,019, entitled “Apparatus and Method for Collaborative Dynamic Video Annotation”, filed on Mar. 13, 1998, assigned to the assignee herein, and the disclosure of which is incorporated by reference herein. The collaborative dynamic video annotation apparatus offers synchronized video playback with multi-party VCR control so that all participants see the same video frame at to the same time. However, their apparatus does not address the issue of how to deliver good quality video when network conditions degrade significantly and when network conditions fluctuate from time to time.

In collaborative video applications, it is not realistic to expect the participants in the group discussion to own the same computer equipment or to physically reside in the same building. It is also not practical to assume each participant has a connection of equal or constant data-rate to the Internet.

Accordingly, it would be desirable and highly advantageous to have a way to collaboratively delivery video over heterogeneous networks. For example, the solution should dynamically convert a video into a high-quality “slide show” so that participants with slow network connections can still comprehend and conduct discussions with participants with fast connections. In such scenario, it is not necessary for all participants to see the same content at the same time in a literal sense. It is, however, important, for all participants to see different versions of the same content at the same time, implying various slide shows and continuous video playbacks are aligned on the same time line. It is also important that slide shows are generated in such a way that makes it easy for participants to comprehend the slide shows in terms of frame quality and semantics. When a participant pauses the video playback, it is important for all to see the same frame on their screen.

### SUMMARY OF THE INVENTION

The problems stated above, as well as other related problems of the prior art, are solved by the present invention, which is directed to collaborative video delivery over heterogeneous networks.

According to an aspect of the present invention, there is provided a system for collaboratively delivering a video stream over a heterogeneous network. The video stream includes a plurality of frames. The system comprises a session controller for synchronizing with client devices, receiving messages, and outputting encoder control commands based on the messages. The system further comprises a plurality of encoders. Each encoder is dedicated to a corresponding one of the client devices for receiving user control commands from the corresponding one of the client devices that correspond to a playback of the video stream, outputting the messages based on the user control commands, and respectively controlling a transmission of the video stream to the corresponding one of the client devices using a timeline shared between the client devices, including respectively and dynamically transmitting or discarding each of the plurality of frames so as to cooperatively maintain a minimum quality of service for all of the client devices.

According to another aspect of the present invention, each of the plurality of encoders dynamically controls the transmission of the video stream further based on a requirement that at least a pre-designated minimum number of frames must be received by all of the client devices. The pre-designated minimum number of frames is comprised in the plurality of frames and corresponds to a basic content of the plurality of frames.

According to yet another aspect of the present invention, each of the plurality of encoders dynamically controls the transmission of the video stream further based on a requirement that at least a pre-designated subset of the plurality of frames must be received by all of the client devices. The pre-designated subset of the plurality of frames corresponds to a basic content of the plurality of frames.

According to still another aspect of the present invention, each of the plurality of encoders dynamically optimizes the transmission of the video stream to the corresponding one of the client devices based on at least a prediction of available bandwidth for the corresponding one of the client devices and the priority of each of the plurality of frames.

According to still yet another aspect of the present invention, each of the plurality of encoders dynamically optimizes the transmission of the video stream to the corresponding one of the client devices based on at least parameters of a respective connection of the corresponding one of the client devices to the system.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram illustrating a general overview of a collaborative video delivery system, according to an illustrative embodiment of the present invention;

FIG. 2 is a block diagram illustrating the structure of a client shown in FIG. 1, according to an illustrative embodiment of the present invention;

FIG. 3 is a block diagram illustrating the structure of the slide server 112 of FIG. 1, according to an illustrative embodiment of the present invention; and

FIG. 4 is a flow diagram illustrating a method for collaboratively delivering a video stream that includes a plurality of frames, according to an illustrative embodiment of the present invention.

### DETAILED DESCRIPTION OF PREFERRED EMBODIMENTS

The present invention is directed to collaborative video delivery over heterogeneous networks. The present invention allows two or more users to simultaneously view the same video content (or different versions of the same video content) provided through one or more wired or mobile networks, where the network connection speed is expected to fluctuate. The present invention intelligently selects and sends frames to each user, while synchronizing the presentation of frames according to the same timeline.

Advantageously, the present invention collaboratively delivers a video stream to two or more client devices while maintaining a minimum quality of service for all client devices. As used herein, the phrase “minimum quality of service” refers the preservation of the basic content of a video stream during a transmission of the video stream in a collaborative video session. That is, the quality of service relates to the transmission of enough frames (in terms of quantity, semantic value, and/or other criteria) from a video stream such that the basic context of the video stream is maintained. In this way, a participant in a collaborative video session may comprehend the basic content of a video stream, despite the fact that a significant number of frames were necessarily dropped in the transmission of the video stream to the participant. Thus, an aim of collaborative video delivery according to the present invention is not only for all participants of a session to see different versions of the same video stream at the same time (e.g., not all frames may be received by all participants due to variations in available bandwidth and so forth), but also to ensure that, at the least, the basic content of the video stream is preserved for all participants.

A brief description will now be given of prerequisites for the collaborative delivery of video according to an illustrative embodiment of the present invention. For a collaborative delivery of video three prerequisites are necessary, namely a clock synchronization of multiple clients on one server, ranking of individual video frames according to their semantic importance, and a proper prediction of available bandwidth.

Accordingly, all clients are synchronized to the server's clock by a clock synchronization algorithm. Thus, separate frames can be sent to a connected client and can be displayed at the correct time, given by the timestamp associated with each frame. Subsequently, this synchronization makes possible a collaborative playback of the video/slideshow for several distributed clients, as all clients are synchronized on the same clock and, thus, are able to display the same content at the same point in time.

The second prerequisite is the ranking of individual video frames according to their semantic importance. For example, the beginning of each story may have the highest importance, followed by the beginning of each sub-story, the beginning of each shot, and the beginning/end of a camera event. Such priority information will make it possible to drop semantically less important frames in order to efficiently use the network bandwidth.

The third basic prerequisite, necessary to stream videos in narrow bandwidth networks, is the prediction of available bandwidth. This prediction makes it possible to transmit frames from the server to the client, so that they arrive at the client, at the latest, at the point of time given by their timestamp. Thus, no bandwidth is wasted by sending unnecessary frames, which would have arrived at the client too late. Subsequently, the proper prediction of available bandwidth is the basis to be able to send frames based upon their priority. If no bandwidth prediction is implemented, then bandwidth cannot be dynamically reserved for higher prioritized frames.

The main part of the video streaming application is the streaming algorithm, which manages the stream of single frames from the server to a connected client. In an illustrative embodiment of the present invention, as one basic value, the streaming algorithm takes the priority assigned to each frame into consideration. Thus, those frames with a higher priority are preferably transmitted to a connected client. According to the illustrative embodiment, the decision of whether or not a frame is sent to a client is based on the frame's priority, the frame's timestamp and the predicted available network capacity. Therefore, video delivery according to the present invention is based on a proper prediction of available bandwidth, and relies on accurate clock synchronization between the server and its connected clients.

A brief description will now be given of the basic structure employed to provide collaborative video delivery over heterogeneous networks according to an illustrative embodiment of the present invention. The video streaming application for narrow bandwidth connections according to an illustrative embodiment of the present invention is based on a core client server architecture provided by REALNETWORKS. This architecture is called Real Media Application Core (hereinafter referred to as “RMA-Core”). The RMA-Core manages the establishment of an RTSP-connection between the client and the server and takes care of the data transfer from the RMA-Server-Core to the RMA-Client-Core.

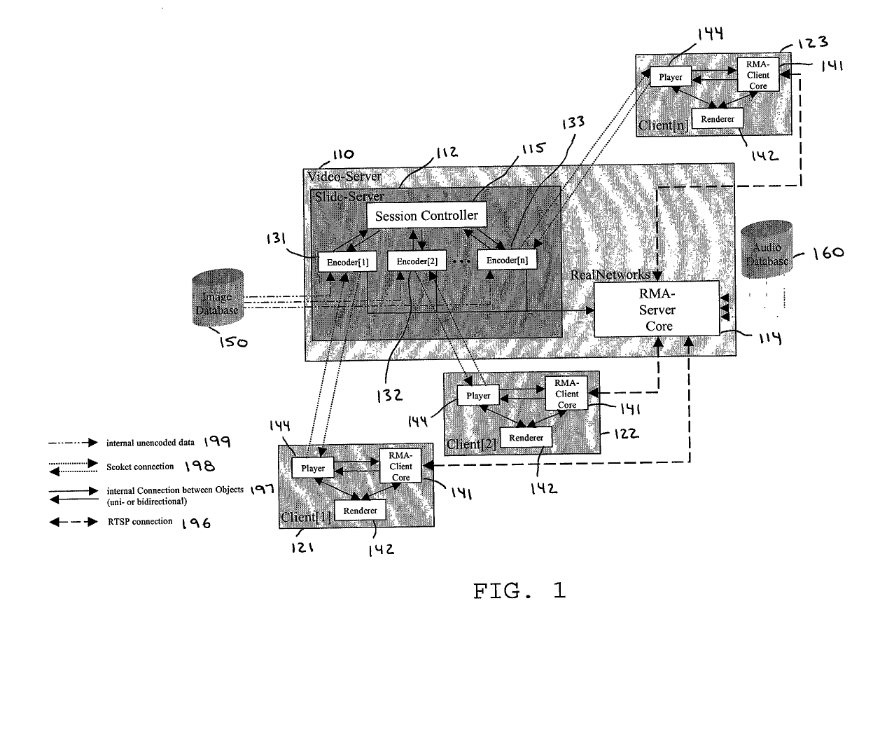

FIG. 1 is a block diagram illustrating a general overview of a collaborative video delivery system, according to an illustrative embodiment of the present invention. The collaborative video delivery system includes a video server 110 and a plurality of clients (client[1] 121, client[2] 122 through client[n] 123). The video server 110 includes a slide server 112 and the RMA-Server core 114. The slide server 112 includes a session controller 115, and a plurality of encoders (encoder[1] 131, encoder[2] 132 through encoder[n] 133). Each of the plurality of clients include an RMA-Client core 141, a renderer 142, and a player 144. The encoders 131-133 are each coupled to an image database 150. The RMA-Server core 114 is coupled to an audio database 160. Communications between the elements of FIG. 1 include: internal unencoded data 199; a socket connection 198; internal connection between objects (uni-or bi-directional) 197; and an RTSP connection 196.

While the present invention is directed to collaborative video delivery to multiple clients, for the sake of brevity and for illustrative purposes the present invention will hereinafter be primarily described with respect to a single client and a single encoder, arbitrarily chosen as client[1] 121 and encoder[1] 131, respectively. However, the description provided hereinafter with respect to the client[1] 121 also applies to client[2] 122 through client[n] 123, and the description provided hereinafter with respect to the encoder[1] 131 also applies to the encoder[2] 132 through the encoder[n] 133.

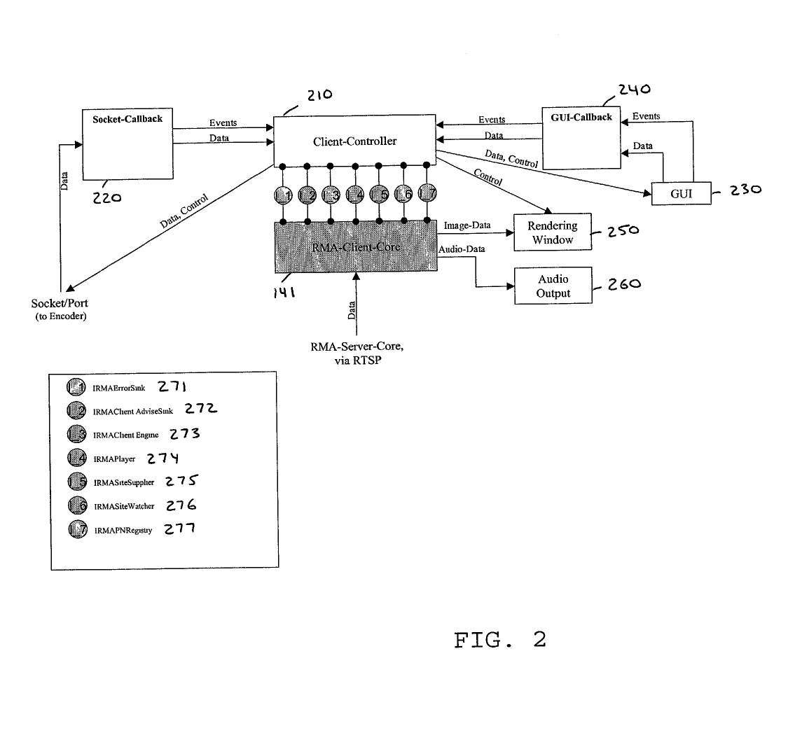

As mentioned above, the present invention transmits separate frames from the video server 110 to the client 121. As it is developed for a mobile network, the present invention is network aware and thus able to react on changing network conditions. The frames selected by the encoder 131 are given, together with additional data associated with that frame, e.g., the frame's timestamp, to the RMA-Server-Core 114 via an RMA-interface. The RMA-Server-Core 114 then sends all the data to the connected client 121 via the previously established RTSP-connection 196. By the use of RMA-interfaces (see FIG. 2 below) provided by the RMA-Client-Core 141, the transmitted frame can be displayed in a window on the client side at the time given by the frame's timestamp.

The second stream, which has to be transmitted to the client 121, is the audio stream. In contrast to video, audio has comparably small bandwidth requirements. Therefore, the SURESTREAM approach of REALNETWORKS is used to transmit the audio data to the connected clients 121-123. Further network awareness for the audio stream is not necessary. Thus, the delivery of the audio stream from the video server 110 to the clients 121-123 is handled completely by the REALNETWORKS' architecture.

Both streams, the video and the audio, are transmitted to the client 121 in parallel; the video stream is handled by the present invention and the thin audio stream is managed by the REALNETWORKS' architecture shown in FIG. 1.

Subsequently, the encoder[1] 131 must also get some information from the connected client 121, such as, e.g., when the client[1] 121 hits one of his VCR control buttons (e.g., Start, Stop, Pause). Unfortunately, the information about the currently available bandwidth is not available via any interface on the server side. Thus, the information has to be transmitted from the client[1] 121, where this information can be retrieved from the RMA-Client-Core 141, to the encoder[1] 131 of the client[1] 121, which is located on the server side.

Therefore, an additional socket connection 198 between the client application and the encoder[1] 131 has to be established (see FIG. 1). This socket connection 198 is used for direct communication between the client application and the encoder[1] 131. Besides the start, stop, and other VCR control messages, the value of the client's current measurement of available bandwidth is transmitted via this socket connection 198. These bandwidth measurements are crucial for the present invention, as the decision of whether a frame is sent to a client or discarded is mainly based on this information.

The session controller 115 manages the collaborative delivery of the video content to all connected clients 121-123. The session controller 115 synchronizes the playback of all clients 121-123 onto each other, such that, for example, if one client hits the pause button, then the video playback is halted at all other clients too.

As soon as a new client (e.g., client[1] 121) registers at the session controller 115, a new encoder (e.g., encoder[1] 131) is generated, which is responsible for transmitting the frames to the connected client. As every client has a connection to the video server 110 with specific network properties, and therefore specific values of available bandwidth, the generation of a separate encoder for every client is necessary. Thus, every client is able to receive a stream that best fits its network properties. The video-stream to each client has to be controlled by a separate encoder for each client, otherwise it cannot be customized for every client.

The advantage of using the REALMEDIA architecture as a basis is at least that one does not have to bother with low-level network problems like establishing and maintaining an RTSP-connection. The existing architecture can be used to hand over a frame or other multimedia data to the RMA-Server-Core 114, which takes care of getting this frame and associated data to the client.

A brief description will now be given of the structure of the client side of the collaborative video delivery system of FIG. 1, according to an illustrative embodiment of the present invention.

FIG. 2 is a block diagram illustrating the structure of a client shown in FIG. 1, according to an illustrative embodiment of the present invention. The client (e.g., any one of client[1] 121, client[2] 122 through client[3] 123) includes a client controller 210, the RMA-Client core 141, a socket callback 220, a graphical user interface (GUI) 230, a GUI callback 240, a rendering window 250, and an audio output 260.

The socket callback 220 is the callback for the management of the socket connection. The GUI callback 240 is the callback for the management of the user interaction. The socket callback 220 and the GUI callback 240 are described in further detail herein below.

The client controller 210 is the central part of each player application. It controls the RMA-Client-Core 141, manages the socket connection via the socket-callback 220 and controls and manages the graphical user interface 230 via the GUI-callback 240.

To control the RMA-Client-Core 141, seven IRMA-interfaces 271-277 (IRMA =Interface Real Media Architecture) are utilized within this application, as shown in FIG. 2. These interfaces are provided by the REALMEDIA SDK and are implemented as COM-objects (COM=Component Object Model). The IRMA-interfaces are as follows: IRMAErrorSink 271; IRMACLientAdviseSink 272; IRMAClientEngine 273; IRMAPlayer 274; IRMASiteSupplier 275; IRMASiteWatcher 276; and IRMAPNRegistry 277.

Via the IRMAErrorSink-interface 271 the client controller 210 is informed about errors that may occur within the RMA-core network. Possible errors within this context include, for example, a failure of the RTSP connection establishment due to a wrong server IP address stated by the user in the location text field, or a loss of connection, and so forth. The IRMAClientAdviseSink-interface 272 informs the client controller 210 about bandwidth changes and the current status of the client, e.g., whether it is currently contacting a server or buffering data. To be able to read values from the clients registry, such as the current value of the available bandwidth, the client controller 210 has to communicate with the RMA-Client-Core 141 via the IRMAPNRegistry-interface 277. The IRMAPNRegistry-interface 277 provides methods to access the clients internal registry. The IRMAClientEngine-interface 273 is necessary to create and manage one or several player interfaces. According to the illustrative embodiment of the present invention just one player interface is necessary to control the data stream via the RTSP connection. Via the player-interface the commands play, stop, seek and pause can be directed to the RMA-Server-Core 114. Thus, the RTSP stream can be controlled from the client controller 210. Subsequently, two more interfaces, namely the IRMASiteSupplier-interface 275 and the IRMASiteWatcher-inteface 276, are used to manage the window in which the image data is displayed. As still some window handling functions within the IRMA-interfaces are missing, the window is additionally controlled directly by the client controller 210 via Windows-API commands (see FIG. 2).

If the client[1] 121 requests the video-stream optimized for narrow bandwidth connections, then the client controller 210 establishes a socket connection 198 to the encoder[1] 131 in addition to the RTSP-connection 196. Therefore, the client 121 first registers at the session controller 115 (see FIG. 1). On the server side, the socket connection 198 is then redirected from the session controller 115 to the newly created encoder (encoder[1] 131). Via the socket connection 198 messages, such as play, stop, seek or pause are sent from the client[1] 121 to the encoder[1] 131. Subsequently, the socket connection 198 is used to transmit the currently available bandwidth to the encoder[1] 131. Based on these values the encoder[1] 131 can update its bandwidth prediction and decide which frame to send. The callback 220 takes care of this socket connection, and reacts on incoming socket events, such as, e.g., a read event or a connect event. All data and events received on this socket are first pre-processed within this callback 220, and then passed to the client controller 210, if necessary.

If the client core needs to transmit data or messages to the encoder[1] 131, e.g., the value of the currently available bandwidth, then the client controller 210 sends this data directly via the local port and the established socket connection to the encoder[1] 131.

All GUI-events, e.g., if the user presses one of the VCR-control buttons or moves the seek-slider, are handled by the GUI-Callback 240. The GUI-Callback 240 receives all notification about the user's actions via the windows messaging loop. Upon these notifications, the GUI-Callback 240 passes events and data, such as the IP-address of the requested server or the identifier of the requested video, to the client controller 210. The client controller 210 can also access the GUI 230, and change its content, for example if the client's current status changes, and therefore the text in the status field must be changed.

The RMA-Client-Core 141 takes care of the client concerning the integration into the REALNETWORKS' architecture. The RMA-Client-Core 141 establishes the RTSP-connection 196 to the video server 110 and manages and controls the incoming video stream, which consists of one image-stream and one audio stream. The RMA-Client-Core 141 converts the frame data to a displayable image format, e.g., a bitmap, and directs this data to a window. Within this window, the video is displayed to the user. The second stream, i.e., the audio stream, is also converted to a playable audio format, and then directed to the audio output channel of the computer.

A brief description will now be given of the structure of the server side of the collaborative video delivery system of FIG. 1, according to an illustrative embodiment of the present invention.

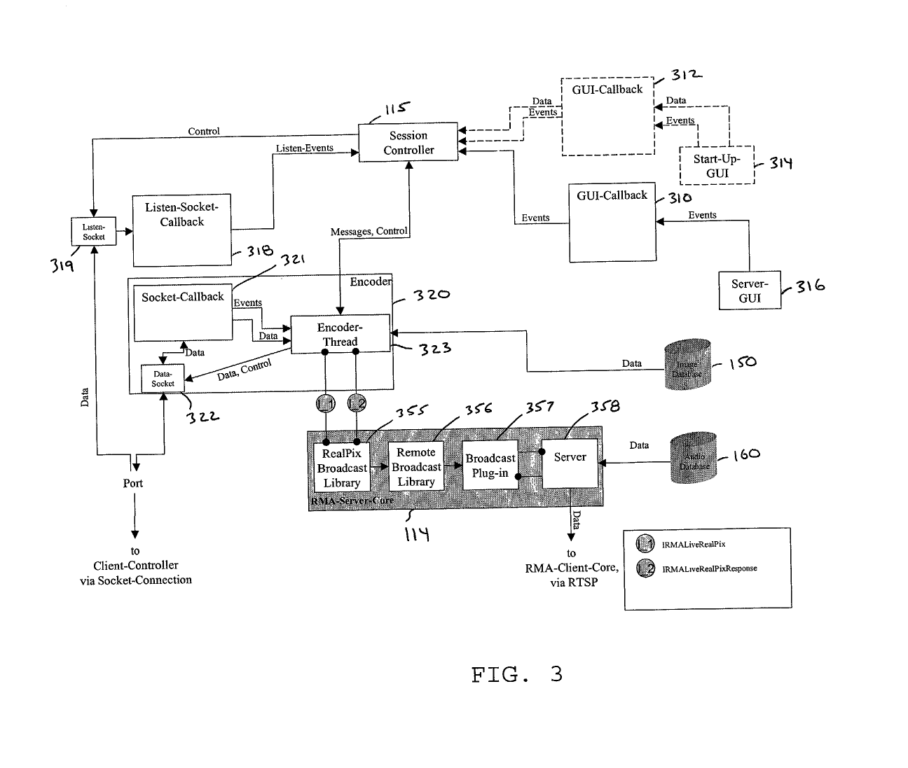

FIG. 3 is a block diagram illustrating the structure of the slide server 112 of FIG. 1, according to an illustrative embodiment of the present invention. The slide server 112 includes the session controller 115, a GUI-callback 310, a GUI-callback 312, a start-up GUI 314, a server GUI 316, a listen-socket-callback 318, a listen socket 319, and one or more encoders (hereinafter “encoder” 320). The encoder 320 can be any of encoders 131-133. The encoder 320 includes a socket-callback 321, a data socket 322, and an encoder thread 323. The RMA server core 114 includes a REALPIX broadcast library 355, a remote broadcast library 356, a broadcast plug-in 357, and a server 358.

The socket callback 321 is the callback for the management of the socket connection. The listen-socket-callback 318 is the callback for the management of new clients. The GUI-callback 312 is the callback for the management of the user interaction for the start-up of the server. The GUI-callback 310 is the callback for the management of the user interaction for the running server. The socket callback 321, the listen-socket-callback 318, the GUI-callback 312, and the GUI-callback 310 are described in further detail herein below.

The session controller 115 is the highest level of the slide server 112. The main tasks of the session controller 115 are the registration of new clients and the collaborative delivery of the video, i.e., the synchronization of the playback of the video between the participating clients. One session controller manages only one video playback within one session, i.e., all clients which register at the session controller can participate at only one video/slides show at the same time. Of course, other configurations may also be employed while maintaining the spirit and scope of the present invention.

The session controller 115 listens on a specified socket port for connect-requests from new clients. As soon as the session controller 115 receives a connect request message on its listen socket 319, the session controller 115 generates a new encoder 320 and a new data-socket 322, and redirects the new participant's socket connection to the new data socket 322. The data which has to then be passed to the new encoder 320 by the session controller 115 are the parameters of the socket connection to the new client, a unique identifier of the RTSP-address at which the encoder 320 has to provide the frames for streaming, i.e., the RTSP-address to where the client has to connect at the RMA-Server-Core 114, and the elapsed time since the start of the video session.

The session controller 115 is responsible for the collaborative delivery of the video to all participating clients. Subsequently, every client should receive that video stream optimally fitted to its connection, i.e., every video stream to each client has to be adapted on the fly to the current network parameters of its specific connection. Thus, every client is able to receive the best achievable video for its connection to the server. To synchronize the video delivered to the different clients, every encoder has to communicate with the session controller 115. If, for example, one client hits the pause button, then the video has to be paused at all clients, too.

As mentioned above, a new encoder 320 is generated by the session controller 115 every time a connect-request message arrives at the session controller 115. The encoder 320 is the part of the slide server 112 that is responsible to stream the low bandwidth optimized video in a network manner to one connected client. One encoder streams frames to only one client to optimize the stream to this client, depending on the specific available bandwidth on this connection. Thus, every client is able to receive the best available Quality of Service (QoS) on its connection.

Every encoder has its own Data-Socket callback function 321, and its own encoder thread 323. The Socket callback 321 handles all events that may occur on the socket connection to the client, such as, e.g., the arrival of a play, a pause, a seek or a stop message.

Unlike the VCR messages, which are passed from the encoder 320 to the session controller 115, the measurements of the available bandwidth on the RTSP-connection, which are transmitted from the client to the encoder 320 via the socket too, are handled only within each encoder separately. On the arrival of this value, the data is stored in a buffer-variable, and a new prediction of the available bandwidth is computed by utilizing a bandwidth prediction algorithm.

Based on the predicted value of available bandwidth, the current playback time, the priority and the timestamp of each frame, the streaming algorithm decides which frame to pass to the RMA-Server-Core 114 to be streamed to its client.

The frame, which has been chosen by the streaming algorithm to be passed to the RMA-Server-Core 114, is loaded from the database and is afterwards passed together with its timestamp via the IRMALiveRealPix-interface 341 to the RMA-Server-Core 114. The second interface used in this server application is the IRMALiveRealPixResponse-interface 342. The IRMALiveRealPixResponse-interface 342 informs the encoder-thread 323 whether the frame was passed successfully to the RMA-Server-Core 114 and whether the RMA-Server-Core 114 is ready to receive the next frame.

Subsequently, the encoder 320 also communicates with the session controller 115, i.e., the encoder 320 passes VCR control messages received from its client, such as play, pause, seek and stop, to the session controller 115. Thus, the playback of the video is synchronized between all clients, as the session controller 115 distributes received VCR messages among all registered encoders.

The GUI-callback 310 handles the interaction with the administrator of the slide server 112 to start the slide server 112. When the administrator hits the ok-button, the entered data, i.e., the login, the password and the slides directory, are passed to the slide server 112. As soon as the slide server 112 is started, the start-up GUI 314 is not necessary anymore, and therefore this dialog is closed after the start-up procedure. Therefore, the start-up GUI 314 is drawn in dashed lines in FIG. 3, as the start-up GUI 314 is present only at the beginning of a session.

The second GUI-callback 312 is active immediately after the slide server 112 is started. The only action that has to be handled until now by the second GUI-callback 312 is the hit of the Cancel-button by the administrator. Further enhancements for the server GUI 316, such as the display of the current status of the slide server 112, are not described in further detail herein. Nonetheless, one of ordinary skill in the related art could readily modify the server GUI 316 with the preceding or other enhancements while maintaining the spirit and scope of the present invention.

For the communication to the participants of a session, two socket callbacks are implemented. The listen-socket callback 318 waits for new connect-requests from new participants and builds up a new socket-connection to this client. On a new connect-request, a message is sent to the session controller 115 which passes the parameters of the new socket connection to the newly generated encoder 320. Within the new encoder 320, the parameters of this new socket connection are associated with the socket callback 321.

Every encoder has its own data-socket callback 321, which is used to transmit data and messages from and to the connected client. The messages are transmitted in both directions, i.e., from the session controller 115 to the encoder and vice versa, of the common VCR-commands. The session controller 115 sends these messages to guarantee the collaborative delivery of the video to all clients, and every client sends such VCR-control message, when one of the clients VCR-control buttons is hit by the user. Subsequently, the current value of available bandwidth is transmitted from the client to the encoder, such that the streaming algorithm of the encoder is able to decide which frame to send.

A brief description will now be given of the collaborative aspects of the present invention, according to an illustrative embodiment of the present invention. The delivery of the video content via a narrow bandwidth connection is built up collaboratively according to the present invention. Collaborative within this context means that every participant of this video session sees different versions of the same content at exactly the same time during the session, and every client is able to control the video-playback of every participant via a multipoint VCR-control.

To make this possible, every client has a kind of virtual VCR-control panel, i.e., if the user of the client presses, for example, the pause button, then the video is not paused instantly at its place. Upon the notification of the GUI-Callback 240 (see FIG. 2), a message is sent to a central VCR-control within the session controller 115, which upon the arrival of this message sends a message via the encoders to all participating clients to make them pause the playback on their local video display.

Thus, the video playback of all clients can be controlled by every participant of the session, with the common VCR-controls pause, play and seek. The “Stop” button of the clients is not collaborative, because if one participant wants to leave the current session then the session does not have to be closed for the other participants. Only the encoder, which belongs to every client on the server side, is closed whenever the associated client hits the Stop-button.

Things become a little more complicated as every client should receive the best Quality of Service available on its connection to the slide server 112. Therefore, the delivery of the video has to be optimized for the specific connection to every client. Simply broadcasting the video content is not possible, because then some clients might receive inferior quality than currently possible via their connection with a higher capacity. Worse than that, some clients would not even be able to participate at the current session because their connections lack available bandwidth due to a currently bad connection to the video server 110. Both cases have to be avoided and, therefore, every client needs a stream that is optimized to its current connection parameters. This can only be achieved by a separate encoder on the server side for every participating client, as shown in FIG. 1.

However, to make a collaborative delivery of the video content possible, all encoders and clients have to be controlled by a higher level. The highest level in this architecture is the session controller 115, as mentioned above.

The collaboration is implemented in such a way, that: if one participant hits the play button, then the video is started at all clients of the current session, if the video has not been started yet; if one participant hits the pause-button, then the video-playback is paused at all clients; and if one participant moves the seek-slider, then the video playback jumps at all clients to the position indicated by the final position of the slider, when the left mouse button is released.

The basic principle of the collaborative delivery is explained as follows. If one user hits a VCR-control button (except Stop) or moves the Seek-Slider, only a message containing some specific information and an identifier of the requested action is sent via the socket connection to the client's encoder (see FIG. 3). Upon arrival of this message on the server side, the encoder analyzes the message, and passes an appropriate message to the session controller 115 (see FIG. 1). The session controller 115 evaluates the incoming message from this encoder and sends a command to all encoders to execute the requested action, i.e., if the client hit the pause button, then the session controller 115 sends a pause message to all encoders. Upon arrival of this message, every encoder executes the requested action, i.e., in this example the encoder thread 323 is stopped such that no more frames are sent to its client. Subsequently, every encoder sends a message to its client, such that the client also performs the necessary actions, i.e., in this example to stop their renderer 142 from displaying frames. By now, the execution of the requested action is complete.

The aim of this collaborative delivery of video content is that all participants of a session see different versions of the same content at the same time. Thus, a meaningful discussion about the displayed content is possible. A possible case scenario might be, for example, that the video shows a complicated repair-workflow of an agricultural machine. The mechanic is now able to watch the workflow together with a support engineer in a remote office; the engineer on his computer and the mechanic on his portable video viewer. With the help of this tool, the mechanic is able to discuss difficult parts of the repair instructions together with the engineer, while additionally both sides are able to pause the video at important scenes or seek the video forward and backward if necessary. These and other useful applications for collaborative video delivery according to the present invention are readily by those of ordinary skill in the art, while maintaining the spirit and scope of the present invention.

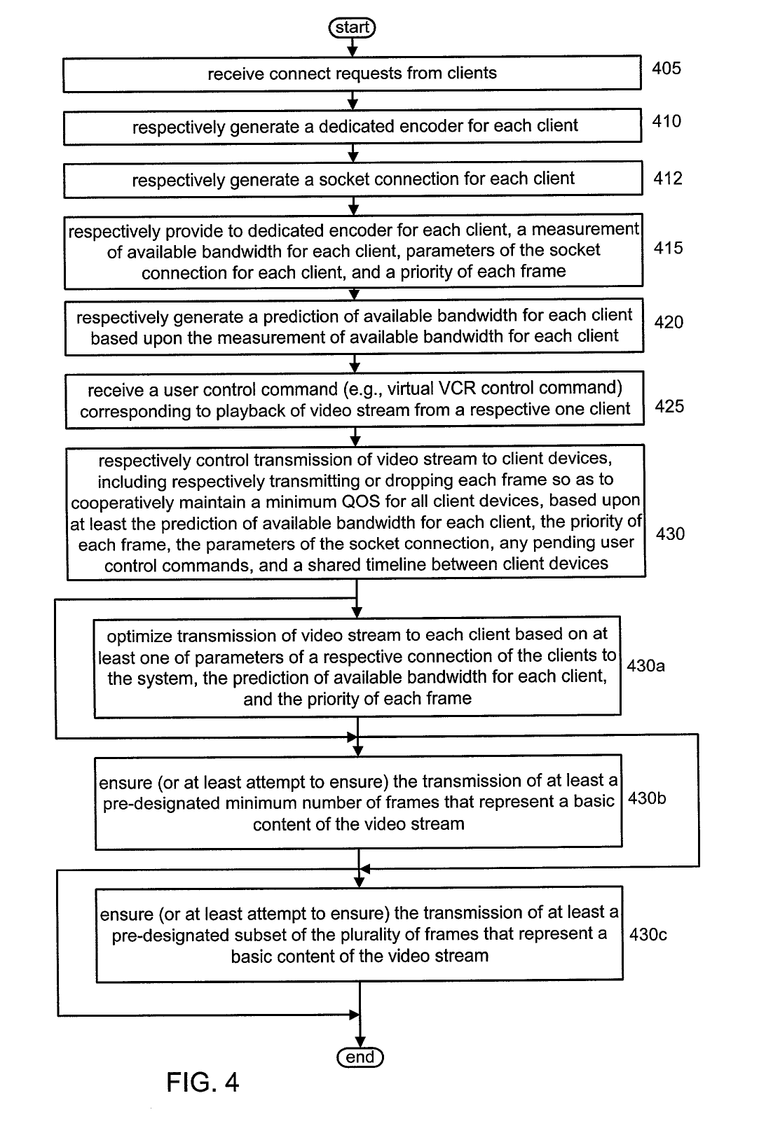

FIG. 4 is a flow diagram illustrating a method for collaboratively delivering a video stream that includes a plurality of frames, according to an illustrative embodiment of the present invention.

Connect requests are received from the clients (step 405). A dedicated encoder is respectively generating for each of the clients (step 410). A socket connection is respectively generated for each of the clients (step 412). A measurement of available bandwidth for each of the clients, parameters of the socket connection for each of the clients, and a priority of each of the plurality of frames are respectively provided to the dedicated encoder for each of the clients (step 415). It is to be appreciated that the parameters include information other than a measurement of available bandwidth. A prediction of available bandwidth for each of the clients is respectively generating based upon the measurement of available bandwidth for each of the clients (step 420). A user control command (e.g., virtual VCR control command) corresponding to a playback of the video stream is received from a respective one of the client devices (step 425).

The transmission of the video stream from each of the encoders to the corresponding one of the client devices is respectively and dynamically controlled, including respectively transmitting or discarding each of the plurality of frames so as to maintain a minimum quality of service for each of the client devices, based upon at least a prediction of available bandwidth for the corresponding one of the client devices, any pending encoder control commands, a priority of each of the plurality of frames, and a shared timeline between the client devices (step 430). Step 430 may include the step of optimizing a transmission of the video stream to each of the clients based on at least one of parameters of a respective connection of the clients to the system, the prediction of available bandwidth for each of the clients, and the priority of each of the plurality of frames (step 430a). Preferably, such optimization is based upon all of the preceding. Moreover, step 430 may include the step of ensuring (or at least attempting to ensure) the transmission of at least a pre-designated minimum number of frames that represent a basic content of the video stream (step 430b), and/or ensuring (or at least attempting to ensure) the transmission of at least a pre-designated subset of the plurality of frames that represent a basic content of the video stream (step 430c).

The user control command allows a user of one of the clients to control the playback of the video stream on all of the clients.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A system for collaboratively delivering a video stream over a heterogeneous network, the video stream including a plurality of frames, the system comprising:
a session controller for synchronizing with client devices, receiving messages, and outputting encoder control commands based on the messages; and
a plurality of encoders, each of the plurality of encoders being dedicated to a corresponding one of the client devices for receiving user control commands from the corresponding one of the client devices that correspond to a playback of the video stream, outputting the messages based on the user control commands, and respectively controlling a transmission of the video stream to the corresponding one of the client devices using a timeline shared between the client devices, including respectively and dynamically transmitting or discarding each of the plurality of frames so as to cooperatively maintain a minimum quality of service for all of the client devices.

2. The system of claim 1, wherein each of said plurality of encoders dynamically controls the transmission of the video stream further based on a requirement that at least a pre-designated minimum number of frames must be received by all of the client devices, the pre-designated minimum number of frames being comprised in the plurality of frames and corresponding to a basic content of the plurality of frames.

3. The system of claim 1, wherein each of said plurality of encoders dynamically controls the transmission of the video stream further based on a requirement that at least a pre-designated subset of the plurality of frames must be received by all of the client devices, the pre-designated subset of the plurality of frames corresponding to a basic content of the plurality of frames.

4. The system of claim 1, wherein each of said plurality of encoders dynamically optimizes the transmission of the video stream to the corresponding one of the client devices based on at least a prediction of available bandwidth for the corresponding one of the client devices and the priority of each of the plurality of frames.

5. The system of claim 1, wherein each of said plurality of encoders dynamically optimizes the transmission of the video stream to the corresponding one of the client devices based on at least parameters of a respective connection of the corresponding one of the client devices to said system.

6. A system for collaboratively delivering a video stream over a heterogeneous network, the video stream including a plurality of frames, the system comprising:
a session controller for synchronizing with client devices, receiving messages, and outputting encoder control commands based on the messages; and
a plurality of encoders, each of the plurality of encoders being dedicated to a corresponding one of the client devices for receiving user control commands from the corresponding one of the client devices that correspond to a playback of the video stream, outputting the messages based on the user control commands, and dynamically and respectively controlling a transmission of the video stream to the corresponding one of the client devices, including respectively transmitting or discarding each of the plurality of frames so as to cooperatively maintain a minimum quality of service for all of the client devices, based upon at least a prediction of available bandwidth for the corresponding one of the client devices, any pending encoder control commands, a priority of each of the plurality of frames, and a shared timeline between the client devices, whereby the user control command allows a user of one of the client devices to control the playback of the video stream on all of the client devices.

7. The system of claim 6, wherein the user control commands correspond to virtual VCR control commands.

8. The system of claim 6, wherein each of said plurality of encoders transmits a client device command to the corresponding one of the client devices based on the encoder control commands, the client device command respectively corresponding to the playback of the video stream on the corresponding one of the client devices.

9. The system of claim 6, wherein each of said plurality of encoders dynamically optimizes the transmission of the video stream to the corresponding one of the client devices based on at least the prediction of available bandwidth for the corresponding one of the client devices and the priority of each of the plurality of frames.

10. The system of claim 6, wherein each of said plurality of encoders dynamically optimizes the transmission of the video stream to the corresponding one of the client devices based on at least parameters of a respective connection of the corresponding one of the client devices to said system.

11. The system of claim 6, wherein said session controller generates each of said plurality of encoders upon respectively receiving a connect request from each of the client devices.

12. The system of claim 6, wherein each of said plurality of encoders dynamically controls the transmission of the video stream further based on a requirement that at least a pre-designated minimum number of frames must be received by all of the client devices, the pre-designated minimum number of frames being comprised in the plurality of frames and corresponding to a basic content of the plurality of frames.

13. The system of claim 6, wherein each of said plurality of encoders dynamically controls the transmission of the video stream further based on a requirement that at least a pre-designated subset of the plurality of frames must be received by all of the client devices, the pre-designated subset of the plurality of frames corresponding to a basic content of the plurality of frames.

14. A method for collaboratively delivering a video stream over a heterogeneous network, the video stream including a plurality of frames, the method comprising the steps of:
generating a plurality of encoders, each of the plurality of encoders being dedicated to a corresponding one of the client devices;
respectively providing to each of the plurality of encoders a measurement of available bandwidth for the corresponding one of the client devices and a priority of each of the plurality of frames;
respectively generating a prediction of available bandwidth for each of the client devices based upon the measurement of available bandwidth;
receiving user control commands, if any, from the client devices, the user control commands corresponding to a playback of the video stream on the client devices; and
respectively and dynamically controlling a transmission of the video stream from the plurality of encoders to the client devices, including respectively transmitting or discarding each of the plurality of frames so as to cooperatively maintain a minimum quality of service for all of the client devices, based upon at least the prediction of available bandwidth for each of the client devices, the priority of each of the plurality of frames, any pending user control commands, and a shared timeline between the client devices, whereby the user control command allows a user of one of the client devices to control the playback of the video stream on all of the clients.

15. The method of claim 14, further comprising the steps of:
respectively generating a data socket connection for each of the client devices; and
respectively providing parameters of the data socket connection for each of the client devices to the plurality of encoders, wherein said parameters include information other than the measurement of available bandwidth, and said controlling step is further based upon the parameters.

16. The method of claim 14, wherein the user control commands correspond to virtual VCR control commands.

17. The method of claim 14, wherein said controlling step comprises the step of respectively and dynamically optimizing the transmission of the video stream to each of the client devices based on at least the prediction of available bandwidth and the priority of each of the plurality of frames.

18. The method of claim 14, wherein said controlling step comprises the step of respectively and dynamically optimizing the transmission of the video stream to each of the client devices based on at least parameters of a respective connection of the client devices to said system.

19. The method of claim 14, wherein said controlling step respectively and dynamically controls the transmission of the video stream to each of the client devices so as to transmit at least a pre-designated minimum number of frames, the pre-designated minimum number of frames being comprised in the plurality of frames and corresponding to a basic content of the video stream.

20. The method of claim 14, wherein said controlling step respectively and dynamically controls the transmission of the video stream to each of the client devices so as to transmit at least a pre-designated subset of the plurality of frames that represent a basic content of the video stream.

21. The method of claim 14, wherein said method is implemented by a program storage device readable by machine, tangibly embodying a program of instructions executable by the machine to perform said method steps.
